(19) United States
(12) Patent Application Publication
(10) Pub. No.: US 2024/0053290 A1
(43) Pub. Date: Feb. 15, 2024

(54) BIOSENSORS

(71) Applicant: PROGNOMICS LTD, Swansea (GB)

(72) Inventors: Daniele DONEDDU, Swansea (GB); Balakrishna ANANTHOJU, Swansea (GB); Rakesh Kumar, Swansea (GB)

(21) Appl. No.: 18/382,615

(22) Filed: Oct. 23, 2023

Related U.S. Application Data
(63) Continuation of application No. PCT/GB2021/000049, filed on Apr. 29, 2021.

(51) Int. Cl. G01N 27/327

(52) U.S. Cl. CPC G01N 27/3276

(57) ABSTRACT

A biosensor includes first and second substrates that define a cavity therebetween. A sensing structure, having a functionalized active surface is provided on the first substrate, within said cavity. A flow control structure is provided on the second substrate, which extends into the cavity, and a gap between the distal end of the flow control structure and the sensing structure provides a fluid flow channel across said functionalized active surface. The biosensor further includes an inlet port, adjacent the proximal end of the flow control structure, at one end of the fluid flow channel, and an outlet port at the opposite end of the fluid flow channel. The flow control structure is shaped and configured such that, in use, fluid injected at the inlet port flows into and through the fluid flow channel to the outlet port, thereby exerting a shear force on the functionalized active surface.

### CROSS-REFERENCE TO RELATED APPLICATIONS

This application is a continuation of PCT International Application PCT/GB2021/000049, filed on Apr. 21, 2021, which is hereby incorporated by reference in its entirety for all purposes.

### FIELD OF THE INVENTION

This invention relates generally to a biosensor, such as a graphene-based biosensor, having an active sensor surface, a method of detecting biological molecules with the biosensor, and a method of fabricating the biosensor. In particular, but not necessarily exclusively, the present invention relates to a biosensor having a patterned and chemically functionalized graphene surface.

### BACKGROUND OF THE INVENTION

Sensors for detecting biological molecules, termed biosensors, are widely known and used in diagnostic testing such as point-of-care testing (POCT). Point-of-care testing is, in essence, diagnostic testing that is performed at or near the site of a patient, with the result leading to a potential change in the care of the patient. Such diagnostic testing is used to detect biological molecules in a biological specimen collected from the patient. A biological molecule within the meaning of the present disclosure is an organic molecule produced by, or occurring in, living organisms. The term ‘biological molecules’ includes, but is not limited to, polymeric molecules occurring in nature and their analogues, such as proteins, polysaccharides, and nucleic acids (including synthetic nucleic acids) as well as small molecules such as primary metabolites, secondary metabolites, and natural products.

Besides optical and other approaches, many biosensors rely on the general principle of generating an electrical signal if the presence or absence of a biological molecule is detected. Structured semiconductor materials are in some cases used to form channels or other structures at the micrometer scale (micro-scale) or nanometer scale (nano-scale).

More recently, graphene has become of interest for use in biosensors because of its unique physical and chemical properties. It has an electrical conductivity of 1000 siemens per metre and thermal conductivities between 1500 and 2500 Wm−1K−1. Furthermore, it exhibits a broad electro-chemical window and a low charge-transfer resistance, and is able to be functionalized by adding bioreceptors which affects its reactivity.

GB2471672B describes a graphene biosensor comprising a patterned graphene layer grown on a SiC substrate. The patterned graphene structure includes at least one channel and an electrical contact is provided on either side of the channel so that a current can pass through it. The channel is functionalized by a linker in the form of a receptor that has a binding affinity for a target (biological) molecule, attached to the graphene surface. An example of such a linker is derived from attaching a nitrobenzene to the graphene surface and its subsequent electrochemical reduction to aniline, although others will be known to a person skilled in the field of chemical functionalization/immobilization. In use, when one or more target biological molecules attach to the functionalized channel and a current is passed along the channel, changes in the electrical properties of the sensor (caused by the target biological molecule) can be measured.

This configuration of a graphene biosensor is known as a graphene field effect transistor (GFET). Because of the high surface-to-volume ratio of graphene, even the smallest concentration of attached biological molecules changes the conductivity of the channel, making GFET biosensors an attractive platform for sensing a wide variety of species such as enzymes, hydrogen peroxides, dopamine and reduced b-nicotinamide adenine dinucleotide (NADH) molecules. Chemiresistive biosensors are also known, wherein the resistance measured in the biosensor increases with an increase in the target biological molecule. Yet another type of graphene biosensor measures drain-source current and the so-called Dirac point (charge neutrality point) shift of a liquid gated GFET upon analyte (or target biological molecule) binding on a functionalized graphene surface.

Key advantages of graphene-based biosensors are their versatility and their sensitivity for sensing a wide variety of different biological molecules or analytes, depending on the functionalization of the graphene surface and the electrical measurement used to sense and quantify them. However, the performance of graphene-based sensors can be adversely affected by a number of typical issues.

A significant known problem in this field is known as non-specific adsorption (NSA). NSA (also known as non-specific binding or ‘biofouling’) occurs as a result of irreversible adsorption of non-specific bio species (i.e. species other than the target biological molecule of interest) at the active sensor surface, which adversely affects the sensitivity and accuracy of the biosensor, and is especially problematic in POCT equipment which does not support stringent cleaning of the sensor surface immediately after the species binding stage and before electronic detection/measurement of results. The presence of NSA on the sensor surface can ‘block’ the active area, thereby reducing the sensitivity and selectivity of the biosensor (e.g. giving a false positive result). In some cases, the presence of NSA also acts to increase a base line known as ‘background noise’ which, in turn, reduces the limit of detection of the biosensor in that lower concentrations of the target biological molecule may be masked. This noise signal, which is indistinguishable from the target biological molecule, as well as any blocking of the active surface area, reduces sensor performance (i.e. sensitivity, reproducibility and dynamic detection range). In a laboratory, NSA can be removed from the sensor surface by stringent cleaning of the sensor with tween-20 mixed phosphate buffer solution (PBS) or PBS only, but this becomes a critical challenge for a small, closed POCT system, in which such a sensor cleaning set-up cannot be incorporated.

It is therefore an ongoing desire, in the field of biosensors, to inhibit NSA and/or to remove NSA at the sensor surface, in order to improve biosensor performance.

To this end, numerous methods of NSA inhibition and/or removal have been proposed. Such methods can be grouped into two general categories, namely passive and active methods respectively. Passive NSA inhibition or prevention methods may be further categorized as physical or chemical passivation. Physical passivation methods are designed to prevent NSA by coating or blocking the unreacted active surface with a blocking agent, such as a protein coating (e.g. bovine serum albumin (BSA)), which inhibits NSA but has been shown to have a high lot-to-lot variability, exhibit cross-reactivity and alter the original surface properties (thereby affecting sensor efficacy). Chemical passivation methods, on the other hand, lead to laborious functionalization processes, high background signal and the prospect of damage to the active sensor surface, as well as the challenge of maintaining the long-term chemical stability of the active sensor surface. Overall, NSA inhibition using a passivation method, whether physical or chemical, often involves the use of harsh chemicals that are not usually appropriate for many biological applications.

In contrast, active NSA inhibition/removal methods have emerged as more promising solutions to this problem in the field of biosensors. Such active methods can be categorized as transducer-based or fluid-based methods. Transducer-based methods use electromechanical or acoustic waves for NSA removal. Fluid-based methods, which have not been widely utilized or documented to date, are intended to create shear forces for removing NSA molecules from the sensor surface using a pressure-driven microfluidic flow. The principal disadvantage of transducer-based methods is the requirement for additional controlled equipment. On the other hand, fluid-based methods of NSA removal require precise fluid manipulation at the region-of-interest (ROI) to efficiently remove NSA. Furthermore, in the few such methods as have been documented in this regard, an electrophoretic alignment of the non-target species was required in order to achieve the desired effect.

Current biosensor systems rely on either a passive method of NSA inhibition and/or removal or an active method. However, prior art biosensors have yet to provide a method of NSA inhibition/removal that provides an efficient, reproducible and robust solution to address the above-described problems.

Thus, in accordance with a first aspect of the present invention, there is provided a biosensor comprising:
first and second substrates defining a cavity therebetween;
a sensing structure having a functionalized active surface provided on the first substrate, within said cavity;
a flow control structure provided on said second substrate and extending into said cavity, wherein a gap between the distal end of the flow control structure and the sensing structure provides a fluid flow channel extending across said functionalized active surface; and
an inlet port adjacent the proximal end of the flow control structure at one end of said fluid flow channel and an outlet port at the opposite end of the fluid flow channel;
wherein the flow control structure is shaped and configured such that, in use, fluid dropped/injected at the liquid inlet port flows into and through the fluid flow channel to said outlet port, thereby exerting a shear force on said functionalized active surface.

Various aspects of the invention are set out in the independent claims, and additional and/or optional features are set out in the dependent claims appended hereto. These and other features of the invention will become apparent from the following detailed description.

### BRIEF DESCRIPTION OF THE DRAWINGS

Embodiments of the present invention will now be described by way of examples only, and with reference to the accompanying drawings, in which:

FIG. 1 is a schematic cross-sectional view of a single biosensor according to an exemplary embodiment of the present invention;

FIG. 2A is a schematic cross-sectional view of the bottom package of the biosensor of FIG. 1;

FIG. 2B to 2D are schematic plain views of a graphene well of a biosensor according to an exemplary embodiment of the invention, at three respective steps of a fabrication process, namely with bottom metal contact (16, 17), with top metal clamping (18), and with passivation layer (19) respectively;

FIG. 3 is a schematic cross-sectional view of the top package of the biosensor of FIG. 1;

FIG. 4 is a schematic cross-sectional view of a multi-biosensor device according to an exemplary embodiment of the present invention;

FIG. 5 is a schematic perspective view of a quarter biosensor device according to an exemplary embodiment of the present invention; and

FIG. 6 is a schematic cross-sectional view of a multi-biosensor device according to an exemplary embodiment of the present invention.

### DETAILED DESCRIPTION OF THE INVENTION

In the following detailed description, an embodiment of the present invention is described, together with a complete wafer-scale fabrication process in respect of an exemplary graphene-based sensor chipset that incorporates a novel microfluidics and chipset packaging that aims to provide one or more of the following, namely i) high sensor specificity, whilst yielding substantially complete NSA removal through the combined advantages of both passive and active methods of NSA removal on a single chipset; ii) electrostatically-assisted binding/immobilization to improve turnaround time (TAT; and iii) real-time multiple electrical quantification (MEQ), both chemi-resistive and GFET. However, it is to be understood that some embodiments might only include one or some of these features and, whilst a preferred embodiment is described in detail herein, the present invention is not necessarily intended to be limited in respect of any specific combination of the features described, except in as much as the scope of the invention is clearly defined by the appended claims.

Early detection of disease biomarkers using a sensitive, selective, rapid, and cost effective POCT systems is essential in disease prognosis/diagnosis and real time patient health monitoring. The attachment of the specific disease biomarkers with the biosensor surface is critical to develop such a simple, rapid, and multiplexed sensing platform to detect various analytes with high specificity and sensitivity. In recent years, a wide range of immunoassay formats (e.g. ELISA, Electrochemical, Chemi-resistive, Optical, Magnetic etc.) have been demonstrated/reported useful for simultaneous detection of multiple analytes from a reference mixture. Additionally, to enhance the analyte capture efficiency, several methods, involving diffusion mixing of analytes using chemical modification of sensor surface complemented by the controlled fluid flow with sophisticated microfluidic channels have been developed. Regardless of their performance and capabilities, their incorporation into a resource-limited setting (e.g. POCT) that requires a simple on-site electronic diagnosis system is restricted due to the need for sophisticated electronic/magnetic detection procedures and operational control systems. Recently, carbon nanotubes (single wall carbon nanotubes, (SW-CNTs) or multiwall carbon nanotubes (MW-CNTs)) have shown tremendous potential application as biosensors. Similarly, graphene—a single atom thick film of hexagonally connected carbon atoms—offers potential applications in the field of biosensors by functionalizing its surface with bio-probes for specific biomarkers. Over the last decade, highly sensitive (electrochemical, chemi-resistive, and field-effect transistor-based) graphene-based biosensors have been reported.

Embodiments of the present invention aim to provide a graphene-based biosensor chipset that can address one or more of three important issues, namely 1) high specificity by a (near) absolute removal of NSA, 2) reduced TAT and 3) an accurate and robust analyte quantification, an issue that has thus far hindered the development of robust electronic biosensor for POCT systems.

Thus, a first aspect of the present invention addresses NSA inhibition/removal and aims to significantly reduce or substantially eliminate NSA molecules from the ROI i.e. sensor surface. This is achieved, in an exemplary embodiment of the present invention as described hereinafter, by means of unique open/closed loop microfluidic channels and using gentle electrical (ac) or electromagnetic agitation, wherein the microfluidic channels yield enhanced hydrodynamic shear force and the directional flow of fluids over the region of interest. A blocking agent, as will be known to a person skilled in the art, can also be used to further enhance the NSA inhibition.

A second aspect of the present invention aims to improve turnaround time (TAT). It will be apparent that minimising TAT in biosensors, especially POCT devices, is a critical factor, and this is achieved, in the following exemplary embodiment, using electrostatic binding and enhancing the speed of such binding by applying a static potential (DC potential) at the capacitive electrode buried beneath the functionalized sensor surface.

A third aspect of the invention addresses the need for (near) real-time MEQ and, to this end, uses both chemi-resistive and GFET measurements. A (near) real-time MEQ can be obtained utilising a novel processing module configured to collect chemi-resistive and Dirac point shifting data upon analyte binding, and to use signal processing techniques for analytic quantification of the target bio-analyte.

It is to be understood, in the following detailed description, that any reference to directional terms such as “upper”, “top”, “bottom”, “lower”, “beneath”, “side”, etc. are merely used in relation (and only apply) to the orientation of the device as illustrated in the accompanying drawings, and these terms are in no way intended to be limiting in terms of the orientation of the device, when in use.

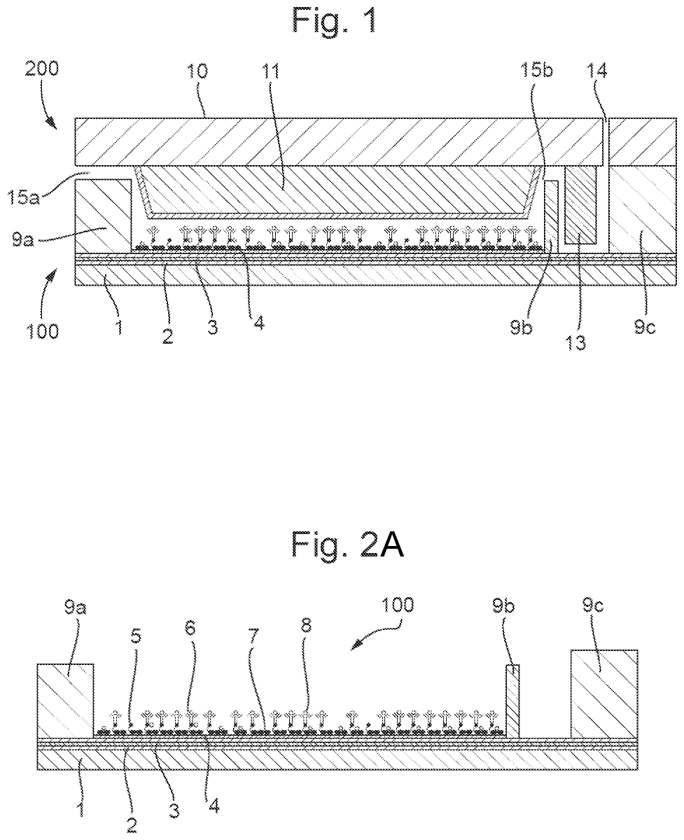

Referring to FIG. 1 of the drawings, a schematic cross-sectional view of a biosensor device according to an exemplary embodiment of the present invention is provided. The device of this example comprises a graphene sensor that can be used for multiple electrical quantification (MEQ) of bio-analytes, with provision for electrically/electromagnetically assisted fluid agitation and forced fluid propagation over the region of interest in an open/closed microfluidic channel, together with electrostatic biasing of graphene to improve TAT. For the purposes of wafer-scale fabrication, the device comprises two separate parts, namely a bottom package 100 and a top package 200. As will be described in more detail hereinafter, the bottom package 100 includes the graphene FETs, microfluidic channels, inlet reservoir, wells/cavities and outer reservoir, whereas the top package 200 includes a solid substrate (for example, glass or other optical-transparent/translucent material), a trapezoid-shaped dome, and polymeric microfluidic channels, fluid control valves, and sample delivery system. The ‘top’ package 200, when integrated with the ‘bottom’ package 100 forms a complete sensor platform for MEQ of bio analytes. In a specific exemplary embodiment described herein, a graphene-based biosensor for detecting cardiac biomarker proteins is referenced, but it will be appreciated that the present invention is not intended to be limited in this regard.

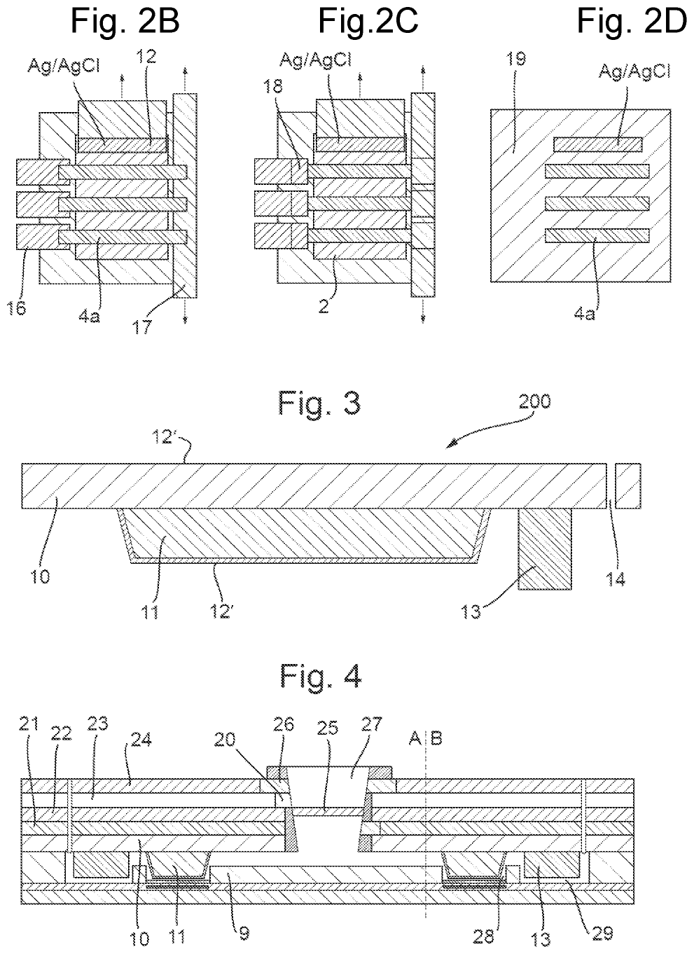

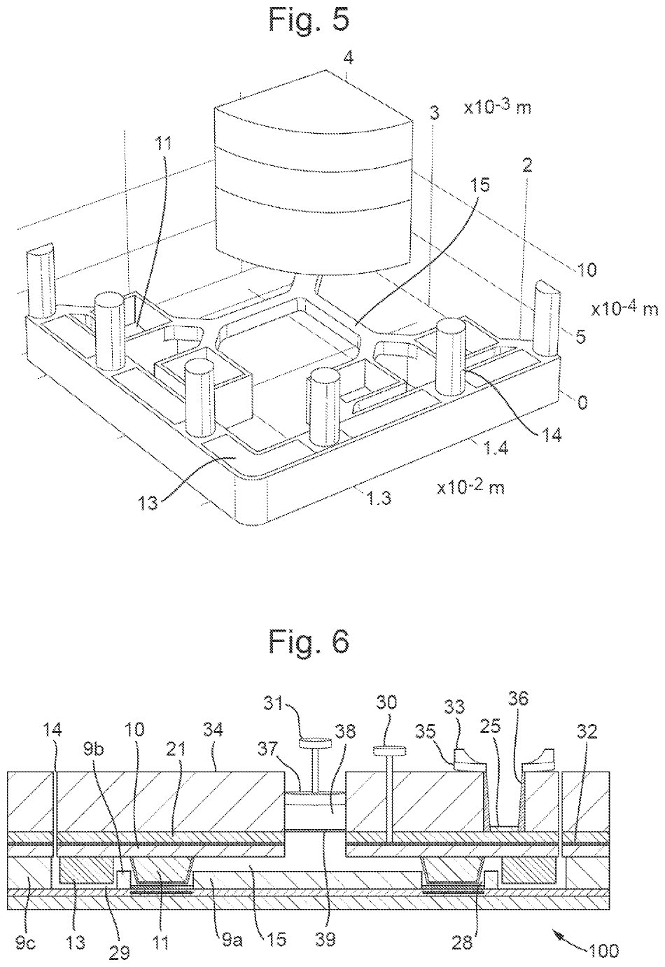

Referring additionally to FIGS. 2A to 2D of the drawings, the ‘bottom’ package 100 of the device comprises a graphene FET-based biosensor. In a method of fabrication of the ‘bottom’ package 100, CVD-grown graphene 4 is directly transferred, onto pre-deposited metal contacts (including an Ag/AgCl reference electrode 12), with graphene being deposited on, in a commonly found implementation, SiO2/Si or (in this specific exemplary embodiment and for the purposes of improving the performance of the sensor system, such as reducing the Dirac point of the graphene sensors) on a self-assembled monolayer (SAM) coated dielectric/insulated SiO2/Si substrate 1, 2. As can be seen more clearly in FIG. 2B of the drawings, graphene channels 4a are patterned after the graphene transfer and cleaning process. As will be known to a person skilled in the art of micro device fabrication, graphene FET-based biosensors can be reliably manufactured in research-oriented clean rooms, for example, and the CVD graphene channels 4a thereof act effectively as active channels for detection of bio-analytes. As shown in FIG. 2B of the drawings, an electrode 16 is located on the substrate 2 ‘beneath’ each graphene channel 4a at one end, and a metal contact 17 extends ‘beneath’ all of the graphene channels 4a at the opposite end thereof. In FIG. 2B, top metal clamping layers 18 can be seen, clamping each end of the graphene channels 4a to the respective electrode 16 at one end and the contact 17 at the other end. In FIG. 2C, a passivation layer 19 can be seen, covering all of the structures on the substrate 2, except the graphene channels 4a and the reference electrode 12.

The graphene channels (denoted generally as ‘4’ in FIGS. 1 and 2A of the drawings) are immobilized with a suitable linker 5, and the probe molecules 6 used will be dependent on the analyte to be detected (for example, in this case, cardiac biomarker proteins). A suitable method for chemically functionalizing the graphene channels is described in, for example, GB Patent No. 2471672 and this method, amongst others, will be known to a person skilled in the art. As such this aspect of the fabrication method will not be discussed in any further detail herein.

Multiple such ‘all graphene’ FETs may be fabricated on a single substrate and fluidly coupled together by microfluidic channels 15 so that the analyte 8 (fluid) can be delivered onto the active (functionalized) graphene region of each device, as illustrated and described in more detail hereinafter with reference to FIG. 4 of the drawings. In FIG. 1 of the drawings, the microfluidic channel 15a defines an inlet port for the illustrated biosensor, the inlet port being defined between a first photoresist structure 9a (e.g. any biocompatible polymer such as SU8) on the substrate 2 and the substrate 10 adjacent the proximal end (largest diameter base) of the dome 11 on the top package 200 (as described hereinafter with reference to FIG. 3 of the drawings). A second polymer structure 9b is provided at the opposite edge of the functionalized active surface 4 and defines an outlet port 15b between its distal end and the substrate 10 of the top package 200. Thus, in use, fluid enters the biosensor via the inlet port 15a and flows through the fluid flow channel defined between the distal end (smaller diameter base) of the dome 11 and the functionalized active surface 4, to the outlet port 15b. A third photoresist/polymer structure 9c is provided on the substrate 2, spaced apart from the second photoresist/polymer structure 9b, such that an outer reservoir 29 is defined between the second and third photoresist/polymer structures. A porous polymer track 13 is provided on the substrate 10 of the top package 200, which extends into the outer reservoir 29, and a pinhole (˜50-100 μm) is provided in the glass substrate 10 of the top package 200 adjacent the end of the outer reservoir 29 (i.e. close to where the third photoresist/polymer structure 9c is located and downstream of the outlet port 15b), as will be described in more detail hereinafter with reference to FIG. 3 of the drawings.

Referring additionally to FIG. 3 of the drawings, the ‘top’ package 200 of the biosensor device comprises a solid (beneficially transparent/translucent, for example, glass) substrate 10, a trapezoid-shaped dome 11, a Ag/AgCl reference electrode 12′ on the dome 11, and a small diameter pinhole 14 (˜50-100 μm) in the glass. The customized dome 11 can be formed of a polymer such as PDMS, SU8, etc., on the glass substrate 10 using, for example, a spin coating/screen printing technique which will be familiar to a person skilled in the art. Furthermore, a highly porous polymer may be deposited (using, for example, spin/spray coating or screen printing) at the edges of the solid substrate 10 so as to incorporate the polymer in the outer reservoir 29 (see FIG. 4) of a multi-sensor package. This polymer helps to ensure that fluid flows in one direction through the device, and helps to avoid backflow due to adsorption of liquid. Moreover, the porous polymer layer prevents fluid flooding in the sensor.

Referring now again to FIG. 4 of the drawings, the top package 200 is integrated with the bottom package 100 to provide a multi-sensor arrangement, the sensors being fluidly coupled together by microfluidic channels 15. The top package 200 is aligned on top of the bottom package 100, such that each trapezoid dome 11 is aligned precisely ‘above’ a respective graphene channel 4a with a small gap therebetween, and the porous polymer track 13 in the outer reservoir 29. The microfluidics configuration further comprises an inlet 27, a well 28 (between the dome 11 and the respective functionalized sensor surface), and an outer reservoir 29 (downstream of each sensor). A plasma separation membrane 25 is provided across the inlet 27. The microfluidic channels 15, the inlet 27, the wells 28 and the outer reservoirs 29 may be fabricated using biocompatible epoxy-based SU8 photoresist, for example. The wells 28 are advantageously created by a first SU8 deposition, and the interconnected microfluidic channels 15 may be created by a second SU8 deposition, but the invention is not necessarily intended to be limited in this regard. Any suitable polymer can be used for the microfluidics fabrication, and the present invention is by no means limited to the use of SU8. Other suitable polymers will be apparent to a person skilled in the art.

In this specific exemplary embodiment of the invention, biotin-streptavadin-biotin-based sandwich-type chemistry is used to immobilize the probe molecules 6 onto the graphene 4. Specific probes (e.g. for cardiac biomarker detection, as in this case) are immobilized onto the graphene using such linking chemistry, as will be familiar to a person skilled in the art.

A gentle ac-electrohydrodynamic or electromagnetic agitation may be applied to each active sensor surface 4, via the above-mentioned electrodes, in a manner that will be familiar to a person skilled in the field of electrochemistry. Any NSA molecules that form on the sensor surface will be ‘loosened’ by such agitation. In one exemplary method, NSA removal may be performed separately from the testing process, or it could be integrated into the testing process, depending on the type of test being performed and required accuracy and specificity, amongst other factors. Thus, in an exemplary method, a sample fluid is dropped/injected into the device via inlet 27, and flows through the microfluidic channels 15. The sample fluid so dropped/injected may be mixed with a dilution fluid, such as phosphate-buffered saline (PBS), before dropping/injecting into the sensor device. Alternatively, the sample fluid may be dropped/injected first, followed by an injection of dilution fluid that mixes with the sample fluid and causes the mixture to flow through the sensor and over the sensor surfaces. The target molecules in the test fluid bind to the probe molecules 6. Any NSA molecules formed on the sensor surface are ‘loosened’ by the above-referenced agitation and caused to be detached from the sensor surface by the flow of fluid through the device (and over the sensor surface). In other words, the pressure-driven fluid flow through the microfluidic channels 15 is used to detach NSA molecules from the active sensor surface. The fluid then flows into the respective outer reservoir 29 and the porous polymer blocks 13 acts to prevent any backflow of the fluid in the opposite direction due to adsorption of liquid. Of course, blocking agents (e.g. a protein coating such as bovine serum albumin (BSA)) may also be provided on the active sensor surface in order to inhibit the NSA thereon. Such passive methods of NSA inhibition will be familiar to a person skilled in the art and serve to enhance the NSA inhibition/removal method of this exemplary embodiment of the present invention.

In the above-described embodiment, the diluted test fluid acts to remove the NSA. However, in alternative embodiments, dilution of the sample fluid within the sensor device may take place separately from the NSA removal step. In this case, following dilution of the test sample, as described above, a fluid (such as PBS may be injected into the device, in order to effect NSA removal. This may be effected via the same microfluidic channels 15 as those used to deliver the test sample and dilution fluid to the active sensor surface. In this case, and in some embodiments, one or more microfluidic valves may be required in order to prevent backflow and cross-flow mixing between the two fluids. In alternative embodiments, to separate microfluidic channel arrangements may be provided.

As discussed in previous sections, a description now follows of calculations and simulations in respect of the microfluidic design of a specific exemplary embodiment of the present invention, to demonstrate its practical feasibility. In order to detach the NSA molecules from the active surface wall, shear stress and shear forces are the key parameters and aspects of the invention offer the possibility of exerting great control over these characteristics using microfluidics. There is a need to apply appropriate shear stress, whilst ensuring that the flow regime over the active sensor surfaces is laminar. Laminar flow and shear stress can be achieved and controlled by adjusting the channel height using microfluidics design. FIG. 4 illustrates an exemplary quarter biosensor device integrated with microfluidics, as described above. The channel dimensions reduced at the sensor surface location by the dome 11, and the trapezoid-shaped dome 11 is configured to generate the shear force and maintain the laminar flow (Re<2300). The height gap between the region of interest (active surface area) and the dome structure and its dimensions defines the generated shear force and pressure. The lower the height gap, the higher will be the shear force generated in the channel. Moreover, shear force can also be controlled by inlet flow rate. From theoretical calculations and modelling, it has been observed that changing the channel height affects the shear stress more than changing the flow rate. As stated above, in order to generate a higher shear stress, the height gap needs to be small, but the nature of the flow should also be laminar. The required shear force to remove NSA molecules depends on the bond dissociation energy between the analyte molecule and the probe molecule. Typically, the bond dissociation energy is higher between probe and analyte molecule because of the specificity and would need a higher shear force to detach the linker, probe, and analyte than would be required to remove the NSA molecules, especially if they have already been ‘loosened by ac-electrohydrodynamic or electromagnetic agitation. Thus, the remaining non-specific molecules presented in the analyte solution bounds weakly (physisorption) to the sensor's surface. These physisorbed NSA molecules can be relatively easily detached from the sensor surface with less shear force than would be required to remove the probe and analyte molecules. The required shear force depends, of course, on the type of linker, probe, and analyte used for the sensor surface fabrication. However, the aim would be to generate a shear force sufficient to remove the NSA molecules.

Theoretical models demonstrate that the fluid shear stress on a cell is equal to the shear stress at the wall for R/h<0.25 where R is the cell diameter and h is the height of the micro fluidic channel. The required wall shear stress, or simply shear stress for removing the NSA molecules, is dependent on the total binding force of the cells. The required channel height to detach a molecule with certain diameter can be estimated from the theoretical calculations. It has been observed that small channel heights produce higher shear stress on the molecules. Computational modelling can, for example, be performed to determine the required dimensions and shear force to remove the NSA molecules. The corner and edge dimensions of the dome can be optimized to minimise the pressure drop in the well. Multiphysics-based modelling can be used to create a suitable microfluidics design with dome.

In an exemplary test method, a sample fluid may be injected (via the inlet into the sensor device) over a period of time, for example, 15 s. Due to the diffusive spreading just before the inlet section, a smooth pulse enters the sensor, that can be described by a Gaussian distribution at the flow cell inlet. The design described and illustrated in the drawings results in more massive shear stress over the narrow region of interest (i.e. over the sensor surface) and lower shear stress in the rest of the channel due to the differences in channel height. The bond dissociation energy between the linker, probe and analyte molecules varies as per their chemical properties. The NSA removal sheer stress ˜2-10 Pa is required to ensure surface cleaning without dissociating the target molecules from the sensor surface. The gap between the dome and ROI may be adjusted precisely to achieve the required shear force to maximise the NSA removal whilst maintain the probes-analyte bond intact and/or dissociating immobilised probes from the sensor surface. As explained above, by controlling the shear force, all the weakly bounded NSA molecules can be removed from the surface. The required shear force can be estimated from the theoretical calculations, and is dependent on the type of linker and probe molecules used for the detection, as will be apparent to a person skilled in the art. Generally, the required shear force to remove the NSA molecules would be around 50% of the adhesive strength. The shear force is tuneable according to the requirement by varying the microfluidic channel dimensions, particularly the height gap between the dome and the active channel.

As described above, the device illustrated and described herein not only acts to remove NSA, but also provides the directional flow of the analyte fluid. Directional flow (preventing the backflow) is essential to avoid the contamination of analyte with NSA molecules. Otherwise, the sensor may show a lot of background noise, and it is challenging to identify the original analyte signal. The pinhole 14 in the glass substrate 10 of the ‘top’ package 200 helps to prevent the blocking of analyte fluid flow in the channels or wells, which may be caused by build-up of internal air pressure. The pinhole 14 can be covered with a gas permeable polymer (e.g. a thin PDMS polymer) layer, which only allows the air to pass through and blocks the fluid. As described above, this complete top package 200 needs to be aligned with the bottom package 100, which creates the fluidic channels for analyte fluid flow. The described device design is also suitable for immobilization of linker, probe, and blocking agents during a manufacturing process, as well as the above-described NSA removal that is facilitated during normal use.

Thus, during a manufacturing process, the top and bottom packages 100, 200 are manufactured separately. The graphene channels 4 of the bottom package may be aligned with respective microneedle-based nozzles for delivering a quantity of functionalization fluid to the active surface(s) within well(s)/cavit(ies), prior to completing the packaging process by aligning the top and bottom packages. By using a device of this design, it is possible to functionalize each well/cavity simultaneously and without cross-contamination. This makes it possible, for example, to provide a multiplexed biosensor device comprising multiple wells/cavities, each well containing multiple graphene channels, where the graphene surface is functionalized to attract a different target molecule. This can be achieved at nanoscale and in a very fast fabrication process.

One of the important requirements for the method of NSA molecule removal using shear force, is to maintain substantially uniform shear force throughout the region of interest with a minimal pressure drop. Ideally, there should be little, or no pressure drop in the channels for the effective removal of NSA molecules. However, there is always a trade-off between channel length and pressure drop in the region of interest (ROI). Higher channel lengths result in a significant pressure drop in the channel, which is not conducive to uniform NSA removal. The channel height is decreased at the region of interest, as described above, to achieve a higher shear force while ensuring that the flow remains laminar. The current invention combines the microfluidic technology and the electrical agitation of the analyte fluid to remove the NSA molecules effectively. The hydrodynamic shear force is tuneable by varying the microfluidic channel dimensions over the ROI in the biosensor. Simultaneous electrical pulse agitation helps to remove the NSA molecules from the surface.

Thus, to summarise, most of the NSA molecules are physisorbed or weakly bound to the sensor surface compared to target analyte molecules. Generally, target analyte molecules bond to the specific probes/receptors via strong chemical interactions. The bond dissociation energy is higher between a particular probe and analyte molecule, and it needs a higher shear force to dissociate the bond compared to the physisorbed NSA molecules. By tuning the appropriate shear force, the weakly bonded NSA molecules can be removed from the surface. The required shear force is optimized in an exemplary embodiment of the present invention for biotin-streptavidin based linker. The described design not only removes the NSA but also provides the directional flow of the analyte liquid. Aspects of the invention provide an efficient method to remove the NSA and segregate the NSA molecules from the active surface.

Immunosensor quantification can be achieved, in prior art biosensors, by collecting an average independent electrical signal from a chemi-resistive, electrochemical, and/or field effect transistor sensors. However, no prior art biosensor structure provides a unique scheme whereby two or more types of signals from a single sensor device are collected and used to provide robust average quantification. In aspects of the present invention, the device structure provides a multiple electrical quantification (MEQ) whilst measuring a chemi-resistive and liquid top/bottom gated G-FET signal on a single device platform. Thus, it offers a robust average quantification (average of chemi-resistive plus liquid gated FET signals) of the measured bioassay data. The real-time MEQ can be achieved by means of a processing module configured to collect multiple data upon analyte binding and perform signal processing to generate an average % change output as analytic quantification of the target bio-analyte.

A fast sensor response time, or achieving a small TAT, is another critical challenge in the field of biosensors, especially for POCT devices used to diagnose critically ill patients and/or in emergency settings, where speed and accuracy is important. TAT is predominantly dependent on chemical reaction kinetics between the bio species (probe and analyte molecules) and graphene surface, which is further defined by the diffusion rates of bio-species in dilution solvents.

In embodiments of the present invention, the bio-species (probe and analyte molecules) binding/immobilization can be speeded up by means of electrical biasing of an electrode buried under the active graphene channel area. The opposite charge present on electrode (electrical biasing) helps to improve the reaction kinetics whilst attracting the biomolecules from the solvent solution towards the graphene surface. This electrostatically assisted probe/analyte binding results in a short turnaround time (TAT), which is highly desired for POCT devices.

Thus, the graphene biosensor device described above (and representing an exemplary embodiment of the invention) can enhance the sensitivity, selectivity, limit of detection and reproducibility of biosensors compared with prior art devices, as well as provide increased suppression of background noise.

It is highly desirable to minimise the manual handling of the POCT system whilst performing clinical diagnosis. The intention of aspects of the invention is to provide a robust automatic system for real sample collection, dilution, delivery and performing a sensitive detection of specific analyte, whilst achieving maximum NSA removal through the proposed active NSA removal scheme described above.

Referring to FIG. 6 of the drawings, a sensor chip package with an alternative top package structure is illustrated schematically. It is to be understood that, where there are features shared with those of the above-described embodiment, like reference numerals are used in FIG. 6. The package illustrated in FIG. 6 includes a pair of micro valves, which can be actuated using electromagnetic/electromechanical means, thereby providing a level of automation of sample mixing, dilution and a controlled NSA removal through air/fluid pressure. Advantages of automation are precise control of fluid flow, pressure required for NSA removal, and TAT.

A description of the biosensor package, when in use, is as follows;

1. Original sample delivery and dilution: The sample delivery platform may comprise a first O-ring 33, which may be made of PTFE or another suitable material with, in this exemplary embodiment, ˜2-3 mm inner diameter and ˜5-7 mm outer diameter, which may be supported (adhered) on a soft rubber second O-ring 35 with inner diameter ˜2-3 mm and outer diameter ˜5-7 mm. The first and second O-rings 33, 35 may further be supporting a tapered polymeric pipette 36 of appropriate volume to hold ˜2-10 μL of Blood sample. The first O-ring 33, second O-ring 35, and pipette 36 all are part of the substrate assembly. The function of these components are as follows:
a. First O-ring 33 (e.g. PTFE/Teflon washer): acts to collect and guide the blood from fingertip into the pipette 36;
b. Second O-ring 35 (e.g. soft rubber) acts as a cushion for the first O-ring 33 (e.g. PTFE/teflon washer) and the (e.g. PTFE) pipette 36.
c. Pipette (-like structure) 36: acts to hold the blood sample and filter plasma through a plasma membrane 25. The membrane 25 inside the pipette also helps in holding the dilution solvent (e.g., PBS) in the reservoir 21 and to avoid leak through the pipette during the transportation. The membrane 25 may be replaced by a porous membrane depending on the type of application (for example, to analyse cleaning waters in a food processing plant for the detection of allergens in food processing or any other samples that do not involve blood, a plasma membrane, specifically, may not necessarily be desired). The volume constituted by the inner diameter of the first O-ring 33 and the portion of the pipette 36 above membrane 25 may define the volume of original sample before dilution.

The blood sample may be delivered directly by touching pricked finger at the centre of the first O-ring 33. The blood plasma filtered through the plasma membrane 25 may mix with a pre-stored dilution medium (e.g., PBS) in the dilution channel/reservoir 21 to provide a predetermined sample concentration. On the other hand, the samples that do not involve blood may be delivered directly into the first O-ring 33 by micropipette so as to travel through the (in this case, porous) membrane 25 to mix with dilution fluid in reservoir 21. The dimension and design of the reservoir 21 can determine the volume of dilution fluid and thus reservoir 21 may be designed to achieve 100, 200, 500 etc. sample dilutions with a given volume of original sample defined by the volume of the pipette. Alternatively, a fixed volume of dilution fluid can be delivered into the channel/reservoir 21 from another reservoir, constructed the top package (not shown in FIG. 6), by means of an electromagnetically/electromechanically actuated valve (similar to the first and second valves 30, 31 shown in this embodiment, and described hereinafter). The volume of the original sample in pipette may also be precisely estimated by means of noncontact optical measurement of volume, as described in, for example, Chinese Patent No. CN104132613. The components of non-contact optical volume measurement can be integrated with an electronic readout system. All the critical components of sample delivery platform are, in this case, required to be bio-compatible.

2. Diluted sample delivery: A first micro valve 30, which may consist of a ferromagnetic material or any polymeric material (e.g. PTFE/Teflon etc), is designed in such a way that it initially blocks the delivery of the diluted sample to the sensors located in cavity 28. The first valve 30 is then actuated by an electromagnetic/electromechanical switch installed in an electronic readout system to open the valve and control the flow of fluid. The electronic actuation (open/close) of the first valve 30 may be programmed through a software program incorporated with data analysis schemes, such that an automation of fluid flow can be achieved. In fact, with the given flow rate of a diluted sample and temporal switching of the first valve 30, it is possible to define the sample dose (in μl) to be delivered to the sensor surface.

3. NSA removal with controlled pressure: NSA removal is achieved through shear force over the ROI. An appropriate magnitude of shear force can be achieved by blowing pressured air/fluid by piston-shaped second valve 31. The second valve 31 may consist of a ferromagnetic or any polymeric material (e.g. PTFE/Teflon etc) and may support a soft polymeric round disk 37. An appropriate amount of fluid can be concealed in an enclosure 38 within the top package, holding piston valve 31 at one end and a porous membrane 39 on the other end. The porous membrane 39 is such that it is permeable to a pressurised air/fluid. The enclosure 38 can be filled, and store, air/fluid, and the reservoir 21 filled with dilution fluid, as well as the fitting of the first O-ring 33, the second O-ring 35 and the assembly of the pipette 36 with the membrane 25, using automated manufacturing methods at industrial scale, and at the time of manufacturing of top package. Again, the actuation of the second valve 31 can be performed by means of an electromagnetic/electromechanical arrangement, as discussed above in para 2. The purpose of this second valve 31 is to provide the required NSA effect whilst pushing the air/fluid into the chamber through the membrane 39, which serves to generate desired pressure at the ROI to remove the NSA from the sensor surfaces (in this case, graphene). The pushed/flushed fluid exiting the channels and cavities in the bottom package may be absorbed by the porous membrane 13 located in reservoir 29. The advantage of using air for NSA removal instead of extra fluid (or the sample fluid) is that it prevents saturation of porous membranes 13 with extra fluid and avoids potential back flow of fluid from reservoir 29 into the cavity 28. Again, the automatic actuation of the second valve 31 can be achieved using a software module, as for the first valve 30, for sample delivery (discussed above in paragraph 2). The programmable electromagnetic/electromechanical actuation of these micro valves 30, 31 could provide automation of sample dilution, dosing, and NSA removal effect, which is much desired for a small handheld POCT system.

It will be apparent to a person skilled in the art, from the foregoing description, that modifications and variations can be made to the described embodiments without departing from the scope of the invention as defined by the appended claims.

1. A biosensor comprising:
first and second substrates defining a cavity therebetween;
a sensing structure having a functionalized active surface provided on the first substrate, within said cavity;
a flow control structure provided on said second substrate and extending into said cavity, wherein a gap between the distal end of the flow control structure and said sensing structure provides a fluid flow channel across said functionalized active surface; and
an inlet port adjacent the proximal end of the flow control structure, at one end of said fluid flow channel, and an outlet port at the opposite end of the fluid flow channel;
wherein the flow control structure is shaped and configured such that, in use, fluid dropped/injected at the inlet port flows into and through the fluid flow channel to the outlet port, thereby exerting a shear force on said active surface.

2. A biosensor according to claim 1, wherein said sensing structure comprises a graphene layer functionalized by linker and probe molecules configured to bind with analyte molecules of interest.

3. A biosensor according to claim 1, wherein said flow control structure comprises an outer surface adjacent the inlet port that is rounded and convex relative to the fluid flow path from said inlet port to said outlet port, and optionally wherein the flow control structure may comprises a trapezoid or truncated dome having substantially parallel planar first and second bases, wherein the diameter of the first base is larger than that of the second base, and wherein the first base is on the second substrate and the second base is located nearest the functionalized active surface, with said gap therebetween.

4. A biosensor according to claim 1, wherein the second substrate is a solid dielectric substrate.

5. A biosensor according to claim 1, wherein the flow control structure comprises a polymer.

6. A biosensor according to claim 1, comprising a first structure on the first substrate, located at a first end of the functionalized active surface and extending into the cavity, wherein a gap between the distal end of the first structure and the second substrate defines said inlet port, and optionally wherein said first structure comprises any biocompatible polymer.

7. A biosensor according to claim 1, comprising a second structure on the first substrate, located downstream of the functionalized active surface, wherein a gap between a distal end of the second structure and the second substrate defines said outlet port, and optionally wherein said second structure comprises any biocompatible polymer or wherein the biosensor

8. A biosensor according claim 1, comprising a second structure on the first substrate, located downstream of the functionalized active surface, wherein a gap between a distal end of the second structure and the second substrate defines said outlet port, and further comprising a third structure located on the first substrate, spaced apart from and downstream of the second structure and the outlet port, wherein a space between the second and third structures defines an outer reservoir, and optionally wherein said third structure comprises a biocompatible polymer, or wherein the biosensor further comprises a porous polymer block extending from the second substrate into the outer reservoir, and optionally wherein a small diameter hole is provided in the second substrate and extends into the outer reservoir, downstream of said porous polymer block.

9. A biosensor according to claim 1, further comprising an electrode located between the sensing structure and the first substrate for applying an electrostatic potential to said sensing structure, and optionally wherein said electrode is located at one end of the sensing structure, and a conductive contact is located at the opposite end, and downstream, thereof, the conductive contact being provided between the first substrate and the sensing structure, and optionally further comprising means for applying an electrostatic potential to said electrode, said electrostatic potential being of a polarity that acts to attract analyte molecules of interest.

10. A biosensor according to claim 1, wherein the sensing structure comprises a plurality of spaced apart channels, each channel defining a functionalized active surface.

11. A biosensor according to claim 1, further comprising a reference electrode on said sensing structure.

12. A biosensor according to claim 1, wherein said functionalized active surface comprises a layer or coating of NSA blocking substance thereon.

13. A biosensor according to claim 1, further comprising means for applying mechanical agitation to said sensing structure, wherein said means for applying mechanical agitation to said sensing structure optionally comprises ac-electrohydrodynamic or electromagnetic agitation means.

14. A biosensor according to claim 1, further comprising a quantification module arranged and configured to receive electrical signals from said sensing structure and determine a presence and/or concentration of analyte molecules of interest in a sample fluid flowing through said fluid flow channel, in use, and optionally wherein said quantification module is configured to determine, from said chemi-resistive and GFET signals, a presence and/or concentration of analyte molecules bound to the functionalized active surface based on an average quantity derived therefrom, or optionally wherein said quantification module is configured to generate an average % change in the combined chemi-resistive and GFET signals represented as an analytic quantification of said analyte molecules of interest.

15. A biosensor according to claim 1, wherein the second substrate is a solid, optically transparent/translucent dielectric.

16. A biosensor device comprising at least two biosensors according to claim 1, fluidly coupled together by microfluidic channels, and optionally comprising an inlet for receiving a quantity of fluid, said inlet being fluidly coupled to each inlet port of a plurality of biosensors.

17. A biosensor comprising:
first and second substrates defining a cavity therebetween;
a sensing structure having a functionalized active surface provided on the first substrate within said cavity, said functionalized active surface including probe molecules configured to bind with analyte molecules of interest;
an inlet port at one end of the sensing structure and an outlet port at an opposite end of the sensing structure, wherein a fluid flow channel extends across said functionalized active surface from the inlet port to the outlet port; and
an electrode located between the sensing structure and the first substrate;
the biosensor further comprising means for applying an electrostatic potential to said functionalized active surface, via said electrode, the polarity of said electrostatic potential being opposite to that of said analyte molecules of interest so as to attract said analyte molecules of interest toward said functionalized active surface, in use.

18. A biosensor comprising:
first and second substrates defining a cavity therebetween;
a sensing structure having a functionalized active surface provided on the first substrate within said cavity, said functionalized surface including probe molecules configured to bind with analyte molecules of interest;
electrical contacts arranged and configured to collect electrical signals from said sensing structure, wherein the electrical properties of the sensing structure are altered, in use, by the presence of analyte molecules of interest bound thereto;
means for collecting chemi-resistive and GFET signals from said sensing structure, via said electrical contacts; and
a quantification module for receiving, in use, said chemi-resistive and GFET signals and determining therefrom a presence and/or concentration of analyte molecules bound to the functionalized active surface based on data derived therefrom.

19. A biosensor according to claim 18, wherein said quantification module is configured to determine, from said chemi-resistive and GFET signals, a presence and/or concentration of analyte molecules bound to the functionalized active surface based on an average quantity derived therefrom, and optionally wherein said quantification module is configured to generate an average % change in the combined chemi-resistive and GFET signals represented as an analytic quantification of said analyte molecules of interest.

20. A method of fabricating a biosensor according to claim 1, the method comprising the steps of:
fabricating a bottom package including a first substrate having thereon a sensing structure including a plurality of channels defining respective sensor surfaces;
presenting said bottom package to a delivery station comprising a plurality of nozzles and aligning each of said plurality of channels with a respective nozzle and delivering thereby a quantity of functionalizing fluid or blocking agent to said respective active surface;
fabricating a top package comprising a second substrate having thereon a plurality of flow control structures;
performing a packaging operation so as to couple the top and bottom packages together with a cavity therebetween, wherein each flow control structure is aligned with a respective channel such that a gap between the distal end of the flow control structure and the respective sensor surface provides a fluid flow channel across said sensor surface, with an inlet port adjacent the proximal end of the flow control structure, at one end of said fluid flow channel, and an outlet port at the opposite end of said fluid flow channel.
